(19) United States
(12) Patent Application Publication
(10) Pub. No.: US 2025/0293301 A1
(43) Pub. Date: Sep. 18, 2025

(54) ELECTROCHEMICAL APPARATUS AND ELECTRONIC APPARATUS CONTAINING SAME

(71) Applicant: Ningde Amperex Technology Limited, Ningde (CN)

(72) Inventors: Junfei LIU, Ningde (CN); Yezhen ZHENG, Ningde (CN); Rui WANG, Ningde (CN); Chao TANG, Ningde (CN)

(73) Assignee: Ningde Amperex Technology Limited, Ningde (CN)

(21) Appl. No.: 19/077,335

(22) Filed: Mar. 12, 2025

(30) Foreign Application Priority Data
Mar. 15, 2024 (CN) 202410302194.4

(51) Int. Cl. H01M 10/0567; H01M 10/0569; H01M 50/531; H01M 50/593

(52) U.S. Cl. CPC H01M 10/0567; H01M 50/531; H01M 50/593; H01M 10/0569; H01M 2300/0025

(57) ABSTRACT

An electrochemical apparatus including an electrode assembly, where the electrode assembly includes a positive electrode, a negative electrode, and tabs, and the tabs extend out of a housing in a first direction. A positive electrode active substance layer has a first positive electrode active substance layer side and a second positive electrode active substance layer side opposite to the first positive electrode active substance layer side in the first direction. A negative electrode active substance layer has a first negative electrode active substance layer side and a second negative electrode active substance layer side opposite to the first negative electrode active substance layer side in the first direction. The tabs includes a positive tab and a negative tab, the positive tab is provided at the first positive electrode active substance layer side and the negative tab is provided at the first negative electrode active substance layer side.

### CROSS REFERENCE TO THE RELATED APPLICATIONS

This application claims the benefit of priority from the Chinese Patent Application No. 202410302194.4, filed on Mar. 15, 2024, the entire content of which is incorporated herein by reference.

### TECHNICAL FIELD

This application relates to the field of energy storage technologies, and in particular, to an electrochemical apparatus and an electronic apparatus containing the same.

### BACKGROUND

Electrochemical apparatuses, such as lithium-ion batteries, are widely used as portable chemical energy in fields and industries such as consumer electronics (for example, smart phones, laptops, and cameras), energy storage products (home energy storage, energy storage power stations, and UPSs), and new energy vehicles due to their advantages such as high energy density, high operation voltage platform, low self-discharge, long service life, and environmental friendliness. As application scenarios of these products diversify, requirements are imposed for higher energy densities in electrochemical apparatuses. For a higher energy density, a capacity per gram of a material can be improved, and a structural design of the electrochemical apparatus also plays a decisive role.

To ensure safety performance of a lithium-ion battery and reduce a risk of lithium precipitation, a size of a negative electrode is typically designed to be significantly larger than that of a positive electrode. However, this leads to a decrease in utilization of a negative electrode active substance.

Therefore, an electrochemical apparatus that can efficiently utilize the negative electrode active substance is needed in this field.

### SUMMARY

A first aspect of this application provides an electrochemical apparatus including an electrode assembly and a housing, where the electrode assembly includes a positive electrode, a negative electrode, a separator, and tabs, and the tabs extend out of the housing in a first direction. The positive electrode includes a positive electrode current collector and a positive electrode active substance layer arranged on at least one surface of the positive electrode current collector, the positive electrode active substance layer has a first positive electrode active substance layer side and a second positive electrode active substance layer side opposite to the first positive electrode active substance layer side in the first direction. The negative electrode includes a negative electrode current collector and a negative electrode active substance layer arranged on at least one surface of the negative electrode current collector, the negative electrode active substance layer has a first negative electrode active substance layer side and a second negative electrode active substance layer side opposite to the first negative electrode active substance layer side in the first direction, and the tabs comprises a positive tab and a negative tab, the positive tab is provided at the first positive electrode active substance layer side and the negative tab is provided at the first negative electrode active substance layer side. In the first direction, the first negative electrode active substance layer side extends beyond the first positive electrode active substance layer side by a width of OH₁, and the second negative electrode active substance layer side extends beyond the second positive electrode active substance layer side by a width of OH₂, where 0.1 mm≤OH₁+OH₂≤5 mm, and 0.01≤OH₁/OH₂≤0.9.

In the electrochemical apparatus, a current flows into the tabs, and a current density increases in an area closer to the tabs and gradually decreases in an area farther away from the tabs. A higher current density generates heat and accelerates diffusion of lithium ions in the electrode, thereby reducing lithium precipitation. Conversely, the area farther away from the tabs is prone to lithium precipitation. In the electrochemical apparatus according to this application, OH₂ is configured to be greater than OH₁, specifically, 0.01≤OH₁/OH₂≤0.9, in this application, an area where the negative electrode exceeds the positive electrode is reduced while safety is ensured. This allows for minimizing a size of the negative electrode, thereby improving utilization of the active substance and enhancing an energy density of a cell.

According to an embodiment of this application, 0.2 mm≤OH₁+OH₂≤4 mm. Even in a case that OH₂+OH₁ is less than 4 mm, lithium precipitation can still be prevented as long as a ratio between OH₂ and OH₁ according to this application is satisfied.

According to an embodiment of this application, 0.1≤OH₁/OH₂≤0.8.

According to an embodiment of this application, an insulation layer is provided on a surface of a side of the positive electrode current collector closest the positive tab, an inner edge of the insulation layer comes into contact or partially overlaps with the first positive electrode active substance layer side, and a width of the insulation layer in the first direction is OH₃, and OH₃>OH₁.

According to an embodiment of this application, OH₁<OH₃<2*OH₁. According to an embodiment of this application, a ratio of a thickness of the insulation layer to a thickness of the positive electrode active substance layer is 40% to 95%. The insulation layer is provided on the first positive electrode side in the second direction. The high insulation and high heat resistance of an insulating material can prevent contact between the positive electrode and negative electrode in the edge area, thereby reducing a short-circuit risk.

According to an embodiment of this application, a ratio of a thickness of the insulation layer to a thickness of the positive electrode active substance layer is 50% to 95%.

According to an embodiment of this application, the insulation layer includes inorganic particles and a binder. The inorganic particles include at least one of Al₂O₃, AlOOH, MgO, BaSO₄, ZrO₂, SiO₂, or TiO₂. The binder includes at least one of PVDF, aramid, polyamide, polyacrylonitrile, acrylate polymer, polyacrylic acid, polyacrylate, sodium carboxymethyl cellulose, polyvinylpyrrolidone, polyvinyl ether, polyvinylidene fluoride, pure acrylic emulsion, or styrene-butadiene rubber; and based on a total mass of the insulation layer, a mass percentage ratio of the inorganic particles to the binder is 9:1 to 7:3.

According to an embodiment of this application, the electrochemical apparatus further includes an electrolyte. The electrolyte includes an additive Sa1. The additive Sa1 includes at least one of a compound represented by formula I, a compound represented by formula II, a compound represented by formula III, or a compound represented by formula IV, where A is selected from Li, Na, K, or Cs.

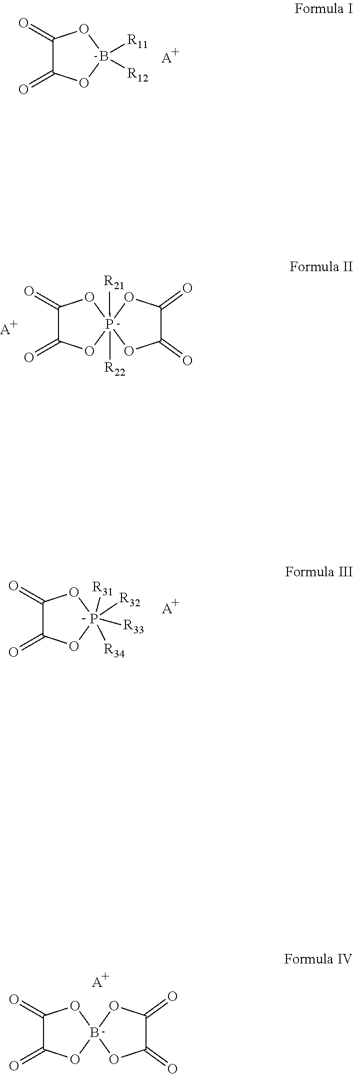

Herein, R₁₁, R₁₂, R₂₁, R₂₂, R₃₁, R₃₂, R₃₃, and R₃₄ are independently selected from —CN, a halogen atom, a C₁-C₄ alkyl group substituted by a halogen atom, a C₂-C₄ alkenyl group substituted by a halogen atom, or a C₂-C₄ alkynyl group substituted by a halogen atom, with a preference for fluorine, a fluorine-substituted C₁-C₄ alkyl group, a fluorine-substituted C₂-C₄ alkenyl group, or a fluorine-substituted C₂-C₄ alkynyl group.

According to an embodiment of this application, the compound represented by formula I includes at least one of the following compounds:

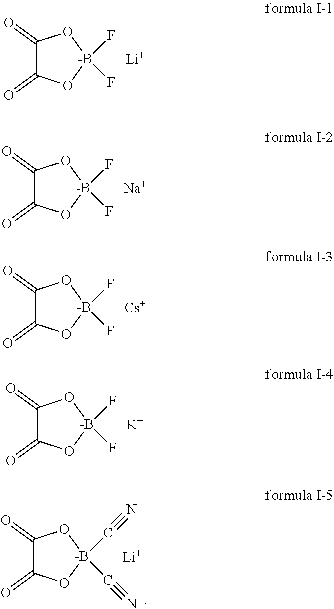

According to an embodiment of this application, the compound represented by formula II includes at least one of the following compounds:

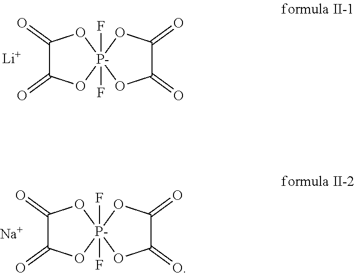 [SMILES: [Li+] ; O=C1O[P-]2(F)(F)(OC1=O)OC(=O)C(=O)O2 ; [Na+] ; O=C1O[P-]2(F)(F)(OC1=O)OC(=O)C(=O)O2]

According to an embodiment of this application, the compound represented by formula III includes at least one of the following compounds:

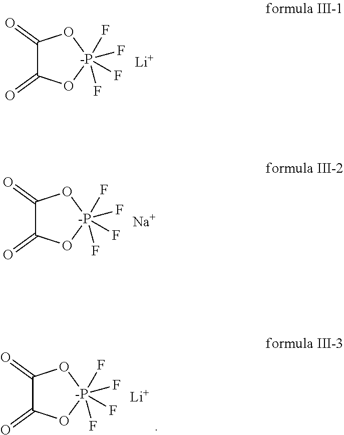

According to an embodiment of this application, the compound represented by formula IV includes at least one of the following compounds:

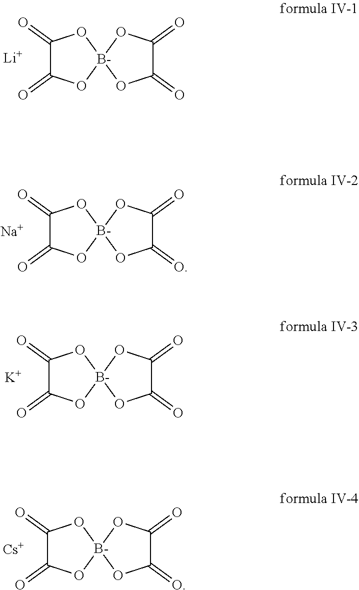

According to an embodiment of this application, the electrolyte includes an additive Sa2, where the additive Sa2 includes A′-PO₂F₂ and A′-BF₄, and A′ is selected from Li⁺, Na⁺, K⁺, or Cs⁺.

According to an embodiment of this application, based on a total mass of the electrolyte, a percentage of the additive Sa1 is 0.1% to 5%, and a percentage of the additive Sa2 is 0.01% to 2%.

The additive Sa1 is hydrolytic. A hydrolysis product can inhibit a short-circuit issue caused by corrosion of a copper foil in the edge area. In addition, the additive Sa1 has high reduction potential, and then a film can be effectively formed on a surface of an electrode plate, so as to reduce side reactions of the electrolyte, improving a reversible capacity of the battery and increasing an energy density. In addition, the additive Sa2 has Lewis acidity, capable of preferentially combining with an amphoteric or weakly basic inorganic material in the insulation layer and preferentially reacting in the edge area. The additive can react with highly active Li to produce an inorganic protective layer such as LiF, LiₓPO_{y}F_{z}, or Li₂SO₃ through decomposition. This results in more uniform lithium deposition, slows down lithium dendrite growth, and effectively passivates precipitated lithium, thereby further enhancing safety performance.

According to an embodiment of this application, the electrolyte includes a first solvent, where a density of the first solvent is no more than 1.0 g/cm³, and based on a total mass of the electrolyte, a mass percentage of the first solvent is 10% to 75%. According to an embodiment of this application, the first solvent includes at least one of diethyl carbonate (DEC), ethylene propyl carbonate, ethyl acetate (EA), ethyl propionate (EP), propyl acetate (PA), propyl propionate (PP), methyl butyrate (MB), ethyl butyrate (EB), or methyl propionate (MP).

According to an embodiment of this application, a length of the electrochemical apparatus in the first direction is 0.5 times to 2 times a length of the electrochemical apparatus in a second direction, where the second direction is perpendicular to the first direction. The length of the electrochemical apparatus in the first direction can indirectly represent a distance between the first negative electrode side and the second negative electrode side of the negative electrode. A greater distance means a larger difference in distribution of current densities and in temperatures on the first negative electrode side and the second negative electrode side, making the area farther away from the tabs more prone to lithium precipitation. However, with the electrochemical apparatus described in this application, due to the configuration of the appropriate ratio between OH₂ and OH₁ and the ratio between the length of the electrochemical apparatus in the first direction and the length in the second direction, the issue of lithium precipitation in OH₁ and OH₂ areas caused by uneven current density distribution and temperature difference can be avoided.

According to a second aspect of this application, this application provides an electronic apparatus, including the electrochemical apparatus according to the first aspect of this application.

### BRIEF DESCRIPTION OF DRAWINGS

FIG. 1 schematically illustrates one embodiment of an electrochemical apparatus according to this application; and

FIG. 2 schematically illustrates another embodiment of an electrochemical apparatus according to this application.

Reference signs: \textcircled{1} positive electrode; \textcircled{2} separator; \textcircled{3} negative electrode; and \textcircled{4} tabs.

### DETAILED DESCRIPTION

Some embodiments of this application are described in detail below. Some embodiments of this application should not be construed as a limitation on the protection scope of this application. Unless otherwise expressly indicated, the following terms used in this specification have the meanings described below.

The term “approximately” used herein is intended to describe and represent a small variation. When used in combination with an event or a circumstance, the term may refer to an example in which the exact event or circumstance occurs or an example in which an extremely similar event or circumstance occurs. For example, when used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. In addition, quantities, ratios, and other values are sometimes presented in the format of ranges in this specification. It should be understood that such format of ranges is used for convenience and simplicity and should be flexibly understood as including not only values explicitly designated as falling within the range but also all individual values or sub-ranges covered by the range as if each value and sub-range are explicitly designated.

In the specific embodiments and the claims, a list of items connected by the term “one of” may mean any of the listed items. For example, if items A and B are listed, the phrase “one of A and B” means only A or only B. In another example, if items A, B, and C are listed, the phrase “one of A, B, and C” means only A, only B, or only C. The item A may include a single element or a plurality of elements. The item B may include a single element or a plurality of elements. The item C may include a single element or a plurality of elements.

In the specific embodiments and the claims, a list of items connected by the term “at least one of”, “at least one kind of”, or other similar terms may mean any combination of the listed items. For example, if items A and B are listed, the phrase “at least one of A and B” or “at least one of A or B” means only A; only B; or A and B. In another example, if items A, B, and C are listed, the phrase “at least one of A, B, and C” or “at least one of A, B, or C” means only A; only B; only C; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

In the specific embodiments and the claims, in expressions regarding a quantity of carbon atoms, that is, a number following the uppercase letter “C”, for example, the number such as “1”, “3”, or “10”0 following “C” in “C₁-C₁₀”, “C₃-C₁₀”, or the like represents a quantity of carbon atoms in a specific functional group. Specifically, the functional groups may include 1 to 10 carbon atoms and 3 to 10 carbon atoms respectively. For example, a “C₁-C₄ alkyl group” or a “C₁₋₄ alkyl group” refers to an alkyl group having 1 to 4 carbon atoms, such as CH₃—, CH₃CH₂—, CH₃CH₂CH₂—, (CH₃)₂CH—, CH₃CH₂CH₂CH₂—, CH₃CH₂CH(CH₃)—, or (CH₃)₃C—.

As used in this specification, the term “alkyl group” refers to a saturated straight-chain hydrocarbon structure having 1 to 10 carbon atoms. The term “alkyl group” is also intended to be a branched or cyclic hydrocarbon structure having 3 to 10 carbon atoms. For example, the alkyl group may be an alkyl group having 1 to 10 carbon atoms, an alkyl group having 1 to 8 carbon atoms, an alkyl group having 1 to 6 carbon atoms, or an alkyl group having 1 to 4 carbon atoms. References to an alkyl group with a specific quantity of carbon atoms are intended to cover all geometric isomers with the specific quantity of carbon atoms. Therefore, for example, “butyl group” is meant to include an n-butyl group, a sec-butyl group, an isobutyl group, a tert-butyl group, and a cyclobutyl group; and “propyl group” includes an n-propyl group, an isopropyl group, and a cyclopropyl group. Examples of the alkyl group include, but are not limited to, a methyl group, an ethyl group, an n-propyl group, an isopropyl group, an cyclopropyl group, an n-butyl group, an isobutyl group, a sec-butyl group, a tert-butyl group, a cyclobutyl group, an n-pentyl group, an isopentyl group, a neopentyl group, a cyclopentyl group, a methylcyclopentyl group, an ethylcyclopentyl group, an n-hexyl group, an isohexyl group, a cyclohexyl group, an n-heptyl group, an octyl group, a cyclopropyl group, a cyclobutyl group, a norbornyl group, and the like. In addition, the alkyl group may be arbitrarily substituted.

The term “alkenyl group” refers to a straight-chain or branched monovalent unsaturated hydrocarbon group having at least one and usually one, two, or three carbon-carbon double bonds. Unless otherwise defined, the alkenyl group usually contains 2 to 10 carbon atoms. For example, the alkenyl group may be an alkenyl group having 2 to 8 carbon atoms, an alkenyl group having 2 to 6 carbon atoms, or an alkenyl group having 2 to 4 carbon atoms. Representative alkenyl groups include (for example) a vinyl group, an n-propenyl group, an isopropenyl group, an n-but-2-enyl group, a but-3-enyl group, and an n-hex-3-enyl group. In addition, the alkenyl group may be arbitrarily substituted.

The term “alkynyl group” refers to a straight-chain or branched monovalent unsaturated hydrocarbon group having at least one and usually 1, 2, or 3 carbon-carbon triple bonds. Unless otherwise defined, the alkynyl group is usually an alkynyl group having 2 to 10 carbon atoms, an alkynyl group having 2 to 8 carbon atoms, an alkynyl group having 2 to 6 carbon atoms, or an alkynyl group having 2 to 4 carbon atoms. Representative alkynyl groups include (for example) an ethynyl group, a prop-2-ynyl (n-propynyl) group, an n-but-2-ynyl group, and an n-hex-3-ynyl group. In addition, the alkynyl group may be arbitrarily substituted.

The term “aryl group” covers monocyclic and polycyclic systems. A polycyclic structure may have two or more rings in which two carbons are shared by two adjacent rings (the rings are “fused”), where at least one of the rings is aromatic, and another ring may be, for example, a cycloalkyl group, a cycloalkenyl group, an aryl group, a heterocyclic ring and/or a heteroaryl group. For example, an aryl group may be an aryl group having 6 to 12 carbon atoms or 6 to 10 carbon atoms. Representative aryl groups include (for example) a phenyl group, a methylphenyl group, a propylphenyl group, an isopropylphenyl group, a benzyl group, a naphth-1-yl group, and a naphth-2-yl group. In addition, the aryl group may be arbitrarily substituted.

When the foregoing substituted group is substituted, unless otherwise specified, the substituted group is substituted with one or more halogens.

As used in this specification, the term “halogen” covers F, Cl, Br, and I, and F or Cl is preferred.

The term “positive electrode active substance” refers to a material capable of reversibly intercalating and deintercalating lithium ions. In some embodiments of this application, the positive electrode active substance includes, but is not limited to, a lithium-containing transition metal oxide.

In the context of this application, a plane where a positive electrode is located, a plane where a negative electrode is located, and a plane where a separator is located are basically parallel.

In the context of this application, “a thickness direction of an electrode plate” is perpendicular to a plane where the electrode plate is located, where an edge length of the electrode plate on the plane is much larger than a thickness of the electrode plate.

### I. Electrochemical Apparatus

The electrochemical apparatus of this application includes any apparatus in which electrochemical reactions take place. Specific examples of the apparatus include all types of primary batteries, secondary batteries, fuel batteries, solar batteries, or capacitors. Especially, the electrochemical apparatus is a lithium secondary battery, including a lithium metal secondary battery, a lithium-ion secondary battery, a lithium polymer secondary battery or a lithium-ion polymer secondary battery, and a sodium secondary battery, including a sodium metal secondary battery, a sodium-ion secondary battery, a sodium polymer secondary battery, or a sodium-ion polymer secondary battery.

The electrochemical apparatus according to this application includes an electrode assembly and a housing, where the electrode assembly includes a positive electrode, a negative electrode, a separator, and tabs, and the tabs extend out of the housing in a first direction. The positive electrode includes a positive electrode current collector and a positive electrode active substance layer arranged on at least one surface of the positive electrode current collector. The positive electrode active substance layer has a first positive electrode active substance layer side and a second positive electrode active substance layer side opposite to the first positive electrode active substance layer side in the first direction. The negative electrode includes a negative electrode current collector and a negative electrode active substance layer arranged on at least one surface of the negative electrode current collector. The negative electrode active substance layer has a first negative electrode active substance layer side and a second negative electrode active substance layer side opposite to the first negative electrode active substance layer side in the first direction. The tabs comprises a positive tab and a negative tab, the positive tab is provided at the first positive electrode active substance layer side and the negative tab is provided at the first negative electrode active substance layer side. In the first direction, the first negative electrode active substance layer side extends beyond the first positive electrode active substance layer side by a width of OH₁, the second negative electrode active substance layer side extends beyond the second positive electrode active substance layer side by a width of OH₂, where 0.1 mm≤OH₁+OH₂≤5 mm, and 0.01≤OH₁/OH₂≤0.9.

In some embodiments, a value of OH₁+OH₂ is, for example, 0.1 mm, 0.5 mm, 1.0 mm, 1.5 mm, 2.0 mm, 2.5 mm, 3.0 mm, 3.5 mm, 4.0 mm, 4.5 mm, 5.0 mm, or any range defined by these values.

In some embodiments, a value of OH₁/OH₂ is 0.01, 0.1, 0.2, 0.3, 0.4, 0.5, 0.6, 0.7, 0.8, 0.9, or any range defined by these values.

In some embodiments, an insulation layer is provided on a surface of a side of the positive electrode current collector close to the tabs. An inner edge of the insulation layer comes into contact or partially overlaps with the first positive electrode active substance layer side. A width of the insulation layer in the first direction is OH₃, where OH₁<OH₃<2*OH₁. For example, OH₃ may be 0.2 times, 0.3 times, 0.4 times, 0.5 times, 0.6 times, 0.7 times, 0.8 times, 0.9 times, 1.0 times, 1.1 times, 1.2 times, 1.3 times, 1.4 times, 1.5 times, 1.6 times, 1.7 times, 1.8 times, 1.9 times as large as OH1, or fall within any range defined by these values. According to one embodiment of this application, a thickness of the insulation layer is 40% to 95% of a thickness of the positive electrode active substance layer, for example, 40%, 45%, 50%, 55%, 60%, 65%, 70%, 75%, 80%, 90%, 95%, or fall within any range defined by these values.

### Positive Electrode

In some embodiments, the positive electrode includes a current collector and a

positive electrode active substance layer located on the current collector. The positive electrode active substance layer includes a positive electrode active substance.

The positive electrode active substance includes at least one lithiated intercalation compound capable of reversibly intercalating and deintercalating lithium ions. In some embodiments of this application, the positive electrode active substance includes a lithium-containing transition metal oxide. In some embodiments, the positive electrode active substance includes a lithium-containing composite oxide. In some embodiments, the lithium-containing composite oxide includes at least one element selected from cobalt, manganese, or nickel.

In some embodiments, the positive electrode active substance may have a coating on its surface, or may be mixed with another compound having a coating. The coating may include at least one coating element compound selected from a coating element oxide, a coating element hydroxide, a coating element hydroxyl oxide, a coating element oxycarbonate, or a coating element hydroxy carbonate. The compound used for the coating may be amorphous or crystalline.

In some embodiments, the coating element contained in the coating may include Mg, Al, Co, K, Na, Ca, Si, Ti, V, Sn, Ge, Ga, B, As, Zr or any combination thereof. The coating can be applied by any method as long as the method does not adversely affect the performance of the positive electrode active substance. For example, the method may include any coating method known in the art, for example, spraying and impregnation.

The positive electrode active substance layer further includes a binder, and optionally includes a conductive material. The binder enhances binding between particles of the positive electrode active substance and also enhances binding between the positive electrode active substance and the current collector.

In some embodiments, the binder includes, but is not limited to, polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, and nylon.

In some embodiments, the conductive material includes but is not limited to a carbon-based material, a metal-based material, a conductive polymer, and a mixture thereof. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector may be, but is not limited to, aluminum.

The positive electrode can be prepared by using a preparation method known in the art. For example, the positive electrode may be obtained by using the following method: mixing an active substance, a conductive material, and a binder in a solvent to prepare an active substance composition, and applying the active substance composition on the current collector. In some embodiments, the solvent may include, but is not limited to, N-methylpyrrolidone.

In some embodiments, the positive electrode is made by forming, on the current collector, a positive electrode material by using a positive electrode active substance layer including lithium transition metal compound powder and a binder.

In some embodiments, the positive electrode active substance layer can usually be made by performing the following operations: dry mixing a positive electrode material and a binder (a conductive material and a thickener as required) to form a sheet, pressing the obtained sheet to the positive electrode current collector, or dissolving or dispersing these materials in a liquid medium to form a slurry, which is applied on the positive electrode current collector and dried.

### Negative Electrode

The negative electrode used in the electrochemical apparatus of this application includes a negative electrode current collector and a negative electrode active substance layer arranged on the negative electrode current collector.

In some embodiments, the negative electrode active substance layer includes a negative electrode active substance.

The specific types of the negative electrode active substance are not specifically limited, and can be selected according to requirements. The negative electrode active substance includes a material capable of reversibly intercalating/deintercalating lithium ions. In some embodiments, the material capable of reversibly intercalating/deintercalating lithium ions includes a carbon material. In some embodiments, the carbon material may be any carbon-based negative electrode active substance commonly used in rechargeable lithium-ion batteries. In some embodiments, the carbon material includes, but is not limited to, crystalline carbon, amorphous carbon, or a mixture thereof. The crystalline carbon may be amorphous, plate-shaped, flake-shaped, spherical or fiber-shaped natural graphite or artificial graphite. The amorphous carbon may be soft carbon, hard carbon, mesophase asphalt carbide, calcined coke, or the like.

In some embodiments, the negative electrode active substance includes, but is not limited to, lithium metal, structured lithium metal, natural graphite, artificial graphite, mesocarbon microbeads (MCMB), hard carbon, soft carbon, silicon, a silicon-carbon composite, a Li—Sn alloy, a Li—Sn—O alloy, Sn, SnO, SnO₂, spinel-structure lithiated TiO₂—Li₄Ti₅O₁₂, a Li—Al alloy, or any combination thereof. The silicon-carbon composite means that silicon approximately accounts for at least 5 wt % of a silicon-carbon negative electrode active substance.

In some embodiments, the negative electrode active substance includes at least one of artificial graphite, natural graphite, hard carbon, soft carbon, a silicon alloy, or a silicon oxide.

When the negative electrode includes a silicon-carbon composite, based on a total weight of the negative electrode active substance, a ratio of silicon to carbon is approximately 1:10 to 10:1, with a median particle size DV₅₀ of the silicon-carbon compound ranging from approximately 0.1 microns to 20 microns. When the negative electrode includes an alloy material, the negative electrode active substance layer can be formed by using methods such as vapor deposition, sputtering, and plating. When the negative electrode includes lithium metal, for example, the negative electrode active substance layer is formed by using a spherical twisted conductive framework and metal particles dispersed in the conductive framework. In some embodiments, the spherical twisted conductive framework may have a porosity of approximately 5% to approximately 85%. In some embodiments, a protective layer may be further provided on the lithium metal negative electrode active substance layer.

In some embodiments, the negative electrode active substance layer may further include a binder, and optionally includes a conductive material. The binder enhances binding between particles of the negative electrode active substance and binding between the negative electrode active substance and the current collector. In some embodiments, the binder includes, but is not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, and nylon.

In some embodiments, the conductive material includes, but is not limited to, a carbon-based material, a metal-based material, a conductive polymer, or a mixture thereof. In some embodiments, the carbon-based material is selected from natural graphite, artificial graphite, carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector includes, but is not limited to, copper foil, nickel foil, stainless steel foil, titanium foil, foamed nickel, foamed copper, a polymer substrate coated with conductive metal, and any combination thereof.

The negative electrode can be prepared by using a preparation method known in the art. For example, the negative electrode may be obtained by using the following method: mixing an active substance, a conductive material, and a binder in a solvent to prepare an active substance composition, and applying the active substance composition on the current collector. In some embodiments, the solvent may include, but is not limited to, water.

### Separator

In some embodiments, the electrochemical apparatus according to this application has a separator provided between the positive electrode and the negative electrode to prevent short circuits. A material and shape of the separator used in the electrochemical apparatus according to this application are not specifically limited, and any technology disclosed in the prior art may be used for the separator. In some embodiments, the separator includes a polymer, an inorganic substance, or the like formed by a material stable to the electrolyte of this application.

For example, the separator may include a matrix layer and a surface treatment layer. The matrix layer is a non-woven fabric, film, or composite film having a porous structure, and the matrix layer is made of a material selected from at least one of polyethylene, polypropylene, polyethylene terephthalate, or polyimide. Specifically, the matrix layer may be a polypropylene porous film, a polyethylene porous film, a polypropylene non-woven fabric, a polyethylene non-woven fabric, or a polypropylene-polyethylene-polypropylene porous composite film. There may be one or a plurality of matrix layers. When there are a plurality of matrix layers, compositions of polymers in different matrix layers may be the same or different, and weight-average molecular weights of the polymers in different matrix layers are not identical. When there are a plurality of matrix layers, pore closing temperatures of the polymers in different matrix layers are different.

In some embodiments, at least one surface of the matrix layer is provided with a surface treatment layer, and the surface treatment layer may be a polymer layer or an inorganic substance layer, or a layer formed by mixing a polymer and an inorganic substance.

In some embodiments, the separator includes a porous matrix and a coating, where the coating includes inorganic particles and a binder.

In some embodiments, a thickness of the coating is approximately 0.5 microns to approximately 10 microns, approximately 1 micron to approximately 8 microns, or approximately 3 microns to approximately 5 microns.

In some embodiments, the inorganic particles are selected from at least one of SiO₂, Al₂O₃, CaO, TiO₂, ZnO₂, MgO, ZrO₂, SnO₂, Al(OH)₃, or AlOOH. In some embodiments, a particle size of the inorganic particle is approximately 0.001 microns to approximately 3 microns.

In some embodiments, the binder is selected from at least one of polyvinylidene fluoride (PVDF), polyvinylidene fluoride-hexafluoropropylene copolymer (PVDF-HFP), polyvinylpyrrolidone (PVP), polyacrylic acid, pure acrylic emulsion (anionic acrylic emulsion obtained through copolymerization of acrylate and a special functional monomer), styrene acrylic emulsion ((styrene-acrylate emulsion) obtained through emulsion copolymerization of monomers of styrene and acrylate), or styrene-butadiene emulsion (SBR, obtained through copolymerization of butadiene and styrene emulsions).

### Electrolyte

In some embodiments, the electrolyte includes an additive Sa1, where the Sa1 includes at least one of a compound represented by formula I, a compound represented by formula II, a compound represented by formula III, or a compound represented by formula IV, A is selected from Li, Na, K, or Cs:

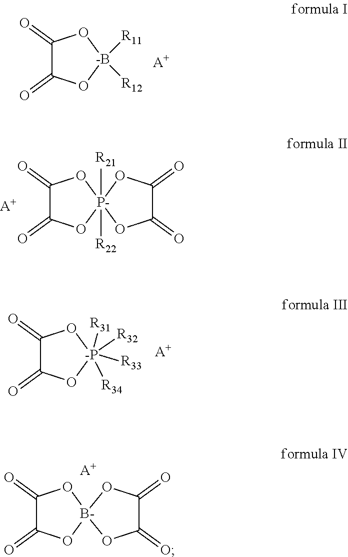

where R₁₁, R₁₂, R₂₁, R₂₂, R₃₁, R₃₂, R₃₃, and R₃₄ are independently selected from —CN, a halogen atom, a C₁-C₄ alkyl group substituted by a halogen atom, a C₂-C₄ alkenyl group substituted by a halogen atom, or a C₂-C₄ alkynyl group substituted by a halogen atom.

In some embodiments, based on a total mass of the electrolyte, content of the additive Sa1 is 0.1% to 10%, for example, 0.1%, 1%, 2%, 3%, 4%, 5%, or any range defined by these values.

In some embodiments, the electrolyte contains an additive Sa2, where the additive Sa2 contains A′-PO₂F₂ and A′-BF₄, and A′ is selected from Li⁺, Na⁺, K⁺, or Cs⁺. Based on a total mass of the electrolyte, a mass percentage of the additive Sa2 is 0.01% to 2%, for example, 0.01%, 0.1%, 0.5%, 1%, 1.5%, 2%, or any range defined by these values.

In some embodiments, the electrolyte includes a lithium salt and a first solvent.

In some embodiments, the lithium salt includes one or more of an inorganic lithium salt or an organic lithium salt. In some embodiments, the lithium salt includes at least one of the fluorine element, the boron element or the phosphorus element. In some embodiments, the lithium salt is selected from one or more of the following lithium salts: lithium hexafluorophosphate LiPF₆, lithium bis(trifluoromethanesulfonyl)imide LiN(CF₃SO₂)₂ (LiTFSI for short), lithium bis(fluorosulfonyl)imide Li(N(SO₂F)₂ (LiFSI for short), lithium hexafluoroarsenate LiAsF₆, lithium perchlorate LiClO₄, or lithium trifluoromethanesulfonate LiCF₃SO₃.

In some embodiments, a concentration of the lithium salt is 0.3 mol/L to 1.5 mol/L. In some embodiments, a concentration of the lithium salt is 0.5 mol/L to 1.3 mol/L or approximately 0.8 mol/L to 1.2 mol/L. In some embodiments, a concentration of the lithium salt is approximately 1.10 mol/L.

In some embodiments, the first solvent includes at least one of diethyl carbonate (DEC), ethylene propyl carbonate, ethyl acetate (EA), ethyl propionate (EP), propyl acetate (PA), propyl propionate (PP), methyl butyrate (MB), ethyl butyrate (EB), or methyl propionate (MP).

In some embodiments, the first solvent accounts for 10% to 75% of the mass of the electrolyte, for example, 10%, 20%, 30%, 40%, 50%, 60%, 70%, 75%, or any range defined by these values.

The electrolyte used in the electrochemical apparatus according to this application is any electrolyte described above in this application. In addition, the electrolyte used in the electrochemical apparatus according to this application may also include other electrolytes that fall within the scope without departing from the essence of this application.

### II. Electronic Apparatus

The electronic apparatus in this application may be any apparatus that uses the electrochemical apparatus in this application.

In some embodiments, the electronic apparatus includes, but is not limited to, a notebook computer, a pen-input computer, a mobile computer, an e-book player, a portable phone, a portable fax machine, a portable copier, a portable printer, a head-mounted stereo headset, a video recorder, a liquid crystal display television, a portable cleaner, a portable CD player, a mini disc, a transceiver, an electronic notebook, a calculator, a storage card, a portable recorder, a radio, a backup power supply, a motor, an automobile, a motorcycle, a motor bicycle, a bicycle, a lighting apparatus, a toy, a game console, a clock, an electric tool, a flashlight, a camera, a large household storage battery, or a lithium-ion capacitor.

To achieve the foregoing objectives and to enable persons skilled in the art to understand the solutions provided in this application, examples of specific implementations of this application are provided below. It should be noted that the described examples are only some rather than all examples of this application.

### III. Test Method

### 1. Hot-Box Test

Battery pre-treatment: A lithium-ion battery is placed in a constant-temperature chamber at 25° C. and left standing for 30 minutes. The battery is charged at a constant current of 1.5 C to a voltage of 4.3V, and then charged at a constant voltage to a current of 0.05 C. The foregoing fully charged battery is vertically suspended in a center of an oven that can be heated, with a temperature raised to 140° C. at a temperature rise speed of 5° C./min for 30 minutes. In a case that the battery does not catch fire or explode, it is considered that the battery passes the test. In each example or comparative example, the test was conducted 10 times, and a quantity of passes was recorded. For example, 1/10 indicates that the battery passes 1 test out of 10 tests.

### 2. Capacity Test Steps

The battery is placed in an environment at 25° C. and left standing for 60 minutes. Then the battery is charged at a constant current of 0.5 C to 4.30V; then charged at a constant voltage of 4.30V to 0.05 C, and left standing for 15 minutes; and then discharged at 0.5° C. to 3.0V. A capacity obtained through this discharge process is a battery capacity, and a platform voltage is 3.69V. Pouch cell energy density GED=battery capacity*platform voltage/battery mass.

A width in the examples and comparative examples corresponds to a size in a first direction in the context of this application, a thickness in the examples and comparative examples corresponds to a size in a thickness direction in the context of this application, and a length in the examples and comparative examples corresponds to a size in a second direction in the context of this application.

### Comparative Example 1-1, Comparative Example 1-2, and Examples 1-1 to 1-9

Preparation of negative electrode: A negative electrode active substance artificial graphite, a thickener sodium carboxymethyl cellulose (CMC), and a binder styrene-butadiene rubber (SBR) were mixed at a weight ratio of 97:1:2. Deionized water was added. A negative electrode slurry was obtained under the action of a vacuum mixer, where a solid content of the negative electrode slurry was 54wt %. The negative electrode slurry was applied uniformly on a copper foil of a negative electrode current collector. The applied copper foil was dried at 85° C., followed by cold pressing, cutting, and slitting, and then was dried under vacuum at 120° C. for 12 hours to obtain a negative electrode plate. A length of the negative electrode plate was 1746.65 mm, a thickness was 0.103 mm, and a width was shown in Table 1.

TABLE 1

| | Negative electrode |
|---|---|
| Number | plate width (mm) |
| Comparative example 1-1 | 64.60 |
| Comparative example 1-2 | 64.60 |
| Example 1-1 | 64.60 |
| Example 1-2 | 64.60 |
| Example 1-3 | 64.60 |
| Example 1-4 | 64.60 |
| Example 1-5 | 64.30 |
| Example 1-6 | 63.60 |
| Example 1-7 | 62.50 |
| Example 1-8 | 62.20 |
| Example 1-9 | 67.00 |

Preparation of positive electrode: A positive electrode active substance LiNi_{0.8}Co_{0.1}Mn_{0.1}O₂, a conductive agent Super P, and a binder polyvinylidene difluoride were mixed at a weight ratio of 97:1.4:1.6. N-methylpyrrolidone (NMP) was added. A positive electrode slurry was obtained under the action of a vacuum mixer, where a solid content of the positive electrode slurry was 72%. The positive electrode slurry was applied uniformly on an aluminum foil of a positive electrode current collector with a thickness of 0.010 mm. The applied aluminum foil was dried at 85° C., followed by cold pressing, cutting, and slitting, and then was dried under vacuum at 85° C. for 4 hours to obtain a positive electrode. A length of the positive electrode plate was 1648.50 mm, a thickness was 0.086 mm, and a width was 62.00 mm.

Preparation of electrolyte: a LiPF₆ electrolyte of 1M was prepared. In a dry argon atmosphere glove box, ethylene carbonate (EC) and diethyl carbonate (DEC) were weighed and mixed at a mass ratio of 3:7. A corresponding additive A was added. After dissolution and thorough stirring, LiPF₆ was added. Then the mixture was uniformly mixed to obtain the electrolyte.

Preparation of separator: A polyethylene (PE) separator with a thickness of 9 μm was used. A final separator was obtained through applying and drying a polyvinylidene fluoride (PVDF) slurry and an Al₂O₃ slurry.

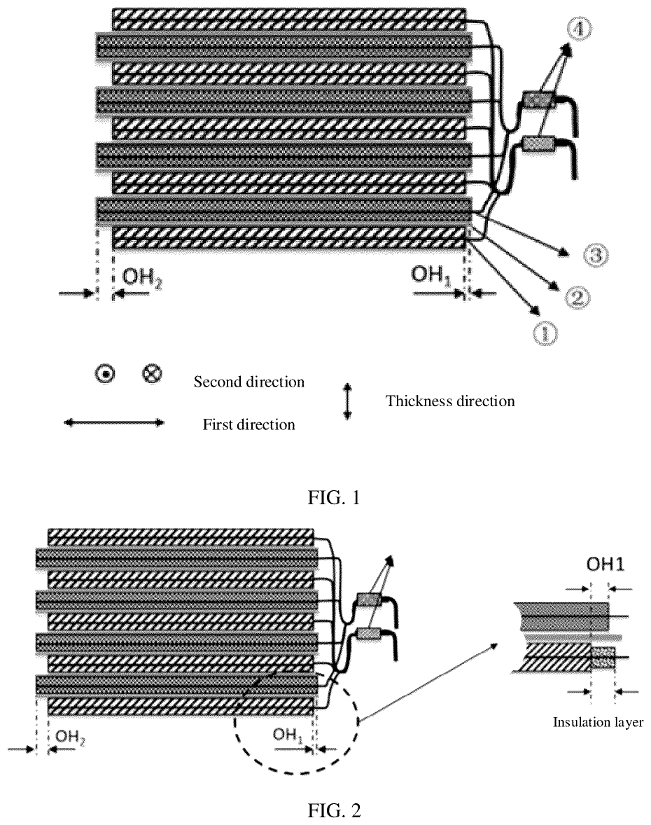

Assembly of lithium-ion battery: The positive electrode, separator, and negative electrode were stacked in sequence, with the separator positioned between the positive electrode plate and the negative electrode plate. Sizes of OH₁ and OH₂ were controlled based on Table 2. After winding and tabs welding, a resulting assembly was placed in an outer packaging aluminum plastic film. As shown in FIG. 1, the tabs were welded at a first positive electrode side and a first negative electrode side, extending in the first direction. The foregoing electrolyte was injected. After vacuum sealing, standing, formation, shaping, and capacity testing, a pouch lithium-ion battery was obtained. After winding was completed, X-ray imaging inspection was performed to confirm the sizes of OH₁ and OH₂ of the battery matched those shown in Table 2.

### Examples 1-10 to 1-16

Examples 1-10 and 1-16 were conducted with reference to Example 1-9. A difference was that in the preparation process of the positive electrode, as shown in FIG. 2, while the positive electrode active substance slurry was applied to the aluminum foil current collector, an insulation layer was applied to a surface of a side of the positive electrode current collector close to the tabs. The insulation layer in Examples 1-10 to 1-13 was obtained through uniformly mixing 90% of Al₂O₃ and 10% of PVDF dissolved in NMP. The insulation layer in Example 1-14 was obtained through uniformly mixing Al₂O₃, ZrO₂, and PVDF dissolved in 5 NMP. The insulation layer in Example 1-15 was obtained through uniformly mixing 70% of BaSO₄, and 30% of PVDF dissolved in NMP. The insulation layer in Example 1-16 was obtained through uniformly mixing TiO₂, SnO₂, and PVDF dissolved in NMP. Thicknesses of the insulation layer on one side and OH₃ in Examples 1-10 to 1-16 were shown in Table 1.

TABLE 2

| | | | | | | Insulation | | | |
|---|---|---|---|---|---|---|---|---|---|
| | | | OH₁ + | | | layer | | | Hot-box |
| | OH₁ | OH₂ | OH₂ | OH₁/ | Insulation | thickness | OH₃ | GED | pass rate |
| | (mm) | (mm) | (mm) | OH₂ | layer | (mm) | (mm) | (Wh/KG) | at 140° C. |
| Comparative | 1.3 | 1.3 | 2.6 | 1.00 | / | / | / | 275.0 | 0/10 |
| example 1-1 | | | | | | | | | |
| Comparative | 1.5 | 1.1 | 2.6 | 1.36 | / | / | / | 275.0 | 0/10 |
| example 1-2 | | | | | | | | | |
| Example 1-1 | 1.23 | 1.37 | 2.6 | 0.90 | / | / | / | 275.0 | 4/10 |
| Example 1-2 | 1 | 1.6 | 2.6 | 0.63 | / | / | / | 275.0 | 5/10 |
| Example 1-3 | 0.5 | 2.1 | 2.6 | 0.24 | / | / | / | 275.0 | 8/10 |
| Example 1-4 | 0.2 | 2.4 | 2.6 | 0.08 | / | / | / | 275.0 | 8/10 |
| Example 1-5 | 1 | 1.3 | 2.3 | 0.77 | / | / | / | 275.4 | 4/10 |
| Example 1-6 | 0.3 | 1.3 | 1.6 | 0.23 | / | / | / | 276.4 | 8/10 |
| Example 1-7 | 0.2 | 0.3 | 0.5 | 0.67 | / | / | / | 280.0 | 5/10 |
| Example 1-8 | 0.05 | 0.15 | 0.2 | 0.33 | / | / | / | 278.5 | 7/10 |
| Example 1-9 | 0.05 | 4.95 | 5 | 0.01 | / | / | / | 271.6 | 8/10 |
| Example 1-10 | 0.2 | 0.3 | 0.5 | 0.67 | Al₂O₃ + | 0.03 | 0.22 | 279.6 | 10/10 |
| | | | | | PVDF | | | | |
| Example 1-11 | 0.2 | 0.3 | 0.5 | 0.67 | Al₂O₃ + | 0.02 | 0.22 | 279.8 | 9/10 |
| | | | | | PVDF | | | | |
| Example 1-12 | 0.2 | 0.3 | 0.5 | 0.67 | Al₂O₃ + | 0.03 | 0.20 | 279.7 | 9/10 |
| | | | | | PVDF | | | | |
| Example 1-13 | 0.2 | 0.3 | 0.5 | 0.67 | Al₂O₃ + | 0.03 | 0.38 | 279.4 | 10/10 |
| | | | | | PVDF | | | | |
| Example 1-14 | 0.2 | 0.3 | 0.5 | 0.67 | Al₂O₃ + | 0.03 | 0.22 | 279.8 | 10/10 |
| | | | | | ZrO₂ + | | | | |
| | | | | | PVDF | | | | |
| Example 1-15 | 0.2 | 0.3 | 0.5 | 0.67 | BaSO₄ + | 0.03 | 0.22 | 279.5 | 10/10 |
| | | | | | PVDF | | | | |
| Example 1-16 | 0.2 | 0.3 | 0.5 | 0.67 | TiO₂ + | 0.03 | 0.22 | 279.5 | 10/10 |
| | | | | | SnO₂ + | | | | |
| | | | | | PVDF | | | | |

“/” means absence.

Comparison between Examples 1-1 to 1-4 and Comparative examples 1-1 and 1-2indicates that in a case that OH₁+OH₂ maintains constant, reducing OH₁ and increasing OH₂ to control the value of OH₁/OH₂ within a range of this application can significantly improve safety performance of the battery. In addition, increasing an OH₂ area can effectively alleviate a safety issue related to lithium precipitation of the battery. This is mainly because the increase in the OH₂ area provides more lithium intercalation space. Conversely, once OH₁/OH₂ exceeds 0.9, even though OH₁+OH₂ remains the same, a desired result cannot be achieved in the hot box test. Further, overly narrow OH₁ unnecessarily increases operational complexity and reduces safety redundancy. Therefore, the range of OH₁/OH₂ is set to be between 0.01 and 0.9. Comparison between Examples 1-5 and 1-6 and Comparative example 1-1 indicates that maintaining OH₂ constant and reducing OH₁ alone can enhance GED while safety performance is ensured.

Comparison between Examples 1-10 and 1-13 and Example 1-7 indicates that the addition of the insulation layer further enhances safety performance of the battery, as the insulation layer ensures that an edge of the positive electrode plate and an edge of the negative electrode plate do not come into contact when the separator shrinks at a high temperature, thus avoiding a short circuit. To avoid affecting stacking of the electrode plates, a thickness of the insulation layer should not exceed a thickness of the positive electrode active substance layer. Considering the insulation property of the insulation layer, the thickness of the insulation layer is set to be between 40% and 95% of the thickness of the positive electrode active substance layer.

### Examples 2-1 to 2-13

Examples 2-1 to 2-13 were conducted with reference to Example 1-7. Additives used in Examples 2-1 to 2-13 were shown in Table 3.

TABLE 3

| | Additive | | | GED | Hot-box pass |
|---|---|---|---|---|---|
| Example | Sa1 | Sa2 | Percentage | (Wh/KG) | rate at 140° C. |
| Example 1-7 | / | / | / | 280.0 | 5/10 |
| Example 2-1 | Formula I-1 | | 0.50% | 280.5 | 8/10 |
| Example 2-2 | Formula I-3 | | 0.50% | 280.6 | 8/10 |
| Example 2-3 | Formula II-1 | | 0.50% | 280.4 | 8/10 |
| Example 2-4 | Formula III-1 | | 0.50% | 280.5 | 8/10 |
| Example 2-5 | Formula IV-1 | | 0.50% | 280.5 | 8/10 |
| Example 2-6 | Formula IV-1 | | 3.00% | 281.0 | 9/10 |
| Example 2-7 | Formula IV-1 | | 5.00% | 281.4 | 10/10 |
| Example 2-8 | / | LiPO₂F₂ | 0.50% | 280.5 | 8/10 |
| Example 2-9 | / | NaPO₂F₂ | 0.50% | 280.4 | 8/10 |
| Example 2-10 | / | LiBF₄ | 0.20% | 280.3 | 7/10 |
| Example 2-11 | Formula I-1 | LiPO₂F₂ | 0.5% + 0.5% | 281.1 | 10/10 |
| Example 2-12 | Formula I-1 + | LiPO₂F₂ | 0.5% + 3.0% + 0.5% | 281.5 | 10/10 |
| | formula IV-1 | | | | |

It can be learned, through comparison, that adding one or more additives Sa1 and Sa2 in Examples 2-1 to 2-12 can enhance the GED of the battery while the safety performance is improved. This is mainly because the additive Sa1 can form a film on an electrode surface during formation, inhibiting side reactions that consume active lithium and reducing capacity loss, and can alleviate a short-circuit issue caused by corrosion of the negative electrode current collector, as a substance of the additive A type can quickly react with precipitated lithium. The additive Sa2 forms an inorganic compound passivating the precipitated lithium that reacts with the electrolyte, leading to heat production, allowing for preferential formation of an inorganic component protective film in the edge area. This improves uniformity of the lithium deposition, slows down lithium dendrite growth, and enhances the safety performance.

Although illustrative embodiments have been demonstrated and described, persons skilled in the art should understand that the foregoing embodiments should not be construed as limitations on this application, these embodiments may be changed, replaced, and modified without departing from the spirit, principle, and scope of this application, and these changes, replacements, and modifications also fall within the protection scope of this application.

What is claimed is:

1. An electrochemical apparatus, comprising an electrode assembly and a housing; wherein the electrode assembly comprises a positive electrode, a negative electrode, a separator, and tabs, and the tabs extend out of the housing in a first direction;
the positive electrode comprises a positive electrode current collector and a positive electrode active substance layer arranged on at least one surface of the positive electrode current collector; the positive electrode active substance layer has a first positive electrode active substance layer side and a second positive electrode active substance layer side opposite to the first positive electrode active substance layer side in the first direction; and
the negative electrode comprises a negative electrode current collector and a negative electrode active substance layer arranged on at least one surface of the negative electrode current collector; the negative electrode active substance layer has a first negative electrode active substance layer side and a second negative electrode active substance layer side opposite to the first negative electrode active substance layer side in the first direction;
the tabs comprises a positive tab and a negative tab, the positive tab is provided at the first positive electrode active substance layer side and the negative tab is provided at the first negative electrode active substance layer side;
wherein in the first direction, the first negative electrode active substance layer side extends beyond the first positive electrode active substance layer side by a width of OH₁, and the second negative electrode active substance layer side extends beyond the second positive electrode active substance layer side by a width of OH₂,
wherein 0.1 mm≤OH₁+OH₂≤5 mm, and 0.01≤OH₁/OH₂≤0.9.

2. The electrochemical apparatus according to claim 1, wherein 0.2 mm≤OH₁+OH₂≤4 mm, and/or 0.1≤OH₁/OH₂≤0.8.

3. The electrochemical apparatus according to claim 1, wherein an insulation layer is provided on a surface of a side of the positive electrode current collector closest the positive tab, an inner edge of the insulation layer comes into contact or partially overlaps with the first positive electrode active substance layer side, and a width of the insulation layer in the first direction is OH₃, wherein OH₁<OH₃<2*OH₁.

4. The electrochemical apparatus according to claim 3, wherein a ratio of a thickness of the insulation layer to a thickness of the positive electrode active substance layer is 40% to 95%.

5. The electrochemical apparatus according to claim 3, wherein the insulation layer comprises inorganic particles and a binder; the inorganic particles comprise at least one of Al₂O₃, AlOOH, MgO, BaSO₄, ZrO₂, SnO₂, or TiO₂;
the binder comprises at least one of PVDF, aramid, polyamide, polyacrylonitrile, acrylate polymer, polyacrylic acid, polyacrylate, sodium carboxymethyl cellulose, polyvinylpyrrolidone, polyvinyl ether, polyvinylidene fluoride, pure acrylic emulsion, or styrene-butadiene rubber;
based on a total mass of the insulation layer, a mass percentage ratio of the inorganic particles to the binder is 9:1 to 7:3.

6. The electrochemical apparatus according to claim 1, wherein the electrochemical apparatus further comprises an electrolyte, the electrolyte comprises an additive Sa1; the additive Sa1 comprises at least one of a compound represented by formula I, a compound represented by formula II, a compound represented by formula III, or a compound represented by formula IV: 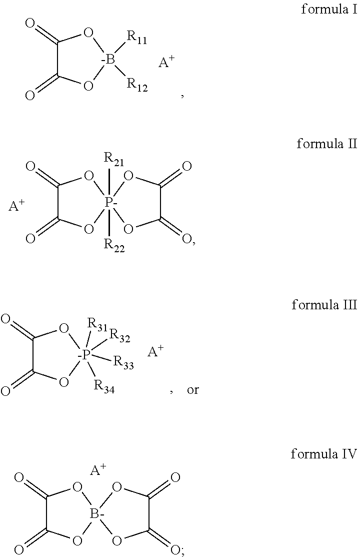
wherein R₁₁, R₁₂, R₂₁, R₂₂, R₃₁, R₃₂, R₃₃, and R₃₄ are independently selected from —CN, a halogen atom, a C₁-C₄ alkyl group substituted by a halogen atom, a C₂-C₄ alkenyl group substituted by a halogen atom, or a C₂-C₄ alkynyl group substituted by a halogen atom; A is selected from Li, Na, K, or Cs.

7. The electrochemical apparatus according to claim 6, wherein the compound represented by formula I comprises at least one of the following compounds: 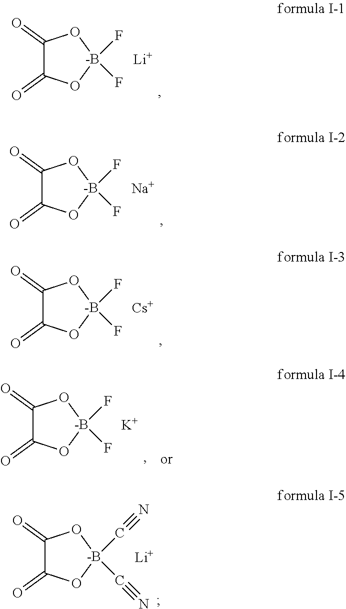
the compound represented by formula II comprises at least one of the following compounds: 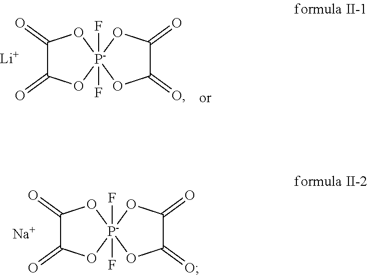 [SMILES: [Li+] ; O=C1O[P-]2(F)(F)(OC1=O)OC(=O)C(=O)O2 ; [Na+] ; O=C1O[P-]2(F)(F)(OC1=O)OC(=O)C(=O)O2]
the compound represented by formula III comprises at least one of the following compounds: 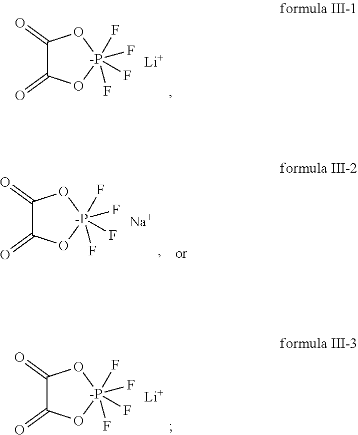
the compound represented by formula IV comprises at least one of the following compounds:

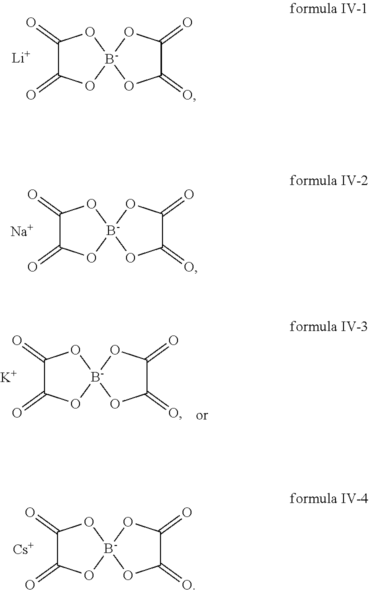

8. The electrochemical apparatus according to claim 6, wherein based on a total mass of the electrolyte, a mass percentage of the additive Sa1 is 0.1% to 5%.

9. The electrochemical apparatus according to claim 1, wherein the electrochemical apparatus further comprises an electrolyte, the electrolyte comprises an additive Sa2, the additive Sa2 comprises A′-PO₂F₂ and A′-BF₄, and A′ is selected from Li⁺, Na⁺, K⁺, or Cs⁺;
based on a total mass of the electrolyte, a mass percentage of the additive Sa2 is 0.01% to 2%

10. The electrochemical apparatus according to claim 1, wherein the electrochemical apparatus further comprises an electrolyte, and the electrolyte comprises a first solvent, wherein a density of the first solvent is no more than 1.0 g/cm³;
based on a total mass of the electrolyte, a mass percentage of the first solvent is 10% to 75%.

11. The electrochemical apparatus according to claim 10, wherein the first solvent comprises at least one of diethyl carbonate (DEC), ethylene propyl carbonate, ethyl acetate (EA), ethyl propionate (EP), propyl acetate (PA), propyl propionate (PP), methyl butyrate (MB), ethyl butyrate (EB), or methyl propionate (MP).

12. The electrochemical apparatus according to claim 1, wherein a ratio of a length of the electrochemical apparatus in the first direction to a length of the electrochemical apparatus in a second direction is 0.5 times to 2 times, the second direction is perpendicular to the first direction.

13. An electronic apparatus, wherein the electronic apparatus comprises an electrochemical apparatus, the electrochemical apparatus comprises an electrode assembly and a housing; wherein the electrode assembly comprises a positive electrode, a negative electrode, a separator, and tabs, and the tabs extend out of the housing in a first direction;
the positive electrode comprises a positive electrode current collector and a positive electrode active substance layer arranged on at least one surface of the positive electrode current collector; the positive electrode active substance layer has a first positive electrode active substance layer side and a second positive electrode active substance layer side opposite to the first positive electrode active substance layer side in the first direction; and
the negative electrode comprises a negative electrode current collector and a negative electrode active substance layer arranged on at least one surface of the negative electrode current collector; the negative electrode active substance layer has a first negative electrode active substance layer side and a second negative electrode active substance layer side opposite to the first negative electrode active substance layer side in the first direction;
the tabs comprises a positive tab and a negative tab, the positive tab is set at the first positive electrode active substance layer side and the negative tab is set at the first negative electrode active substance layer side;
wherein in the first direction, the first negative electrode active substance layer side extends beyond the first positive electrode active substance layer side by a width of OH₁, and the second negative electrode active substance layer side extends beyond the second positive electrode active substance layer side by a width of OH₂,
wherein 0.1 mm≤OH₁+OH₂≤5 mm, and 0.01≤OH₁/OH₂≤0.9.

14. The electronic apparatus according to claim 13, wherein 0.2 mm≤OH₁+OH₂≤4 mm, and/or 0.1≤OH₁/OH₂≤0.8.

15. The electronic apparatus according to claim 13, wherein an insulation layer is provided on a surface of a side of the positive electrode current collector closest the positive tab, an inner edge of the insulation layer comes into contact or partially overlaps with the first positive electrode active substance layer side, and a width of the insulation layer in the first direction is OH₃, wherein OH₁<OH₃<2*OH₁.

16. The electronic apparatus according to claim 15, wherein a ratio of a thickness of the insulation layer to a thickness of the positive electrode active substance layer is 40% to 95%.

17. The electronic apparatus according to claim 15, wherein the insulation layer comprises inorganic particles and a binder; the inorganic particles comprise at least one of Al₂O₃, AlOOH, MgO, BaSO₄, ZrO₂, SnO₂, or TiO₂;
the binder comprises at least one of PVDF, aramid, polyamide, polyacrylonitrile, acrylate polymer, polyacrylic acid, polyacrylate, sodium carboxymethyl cellulose, polyvinylpyrrolidone, polyvinyl ether, polyvinylidene fluoride, pure acrylic emulsion, or styrene-butadiene rubber;
based on a total mass of the insulation layer, a mass percentage ratio of the inorganic particles to the binder is 9:1 to 7:3.

18. The electronic apparatus according to claim 13, wherein the electrochemical apparatus further comprises an electrolyte, the electrolyte comprises an additive Sa1; the additive Sa1 comprises at least one of a compound represented by formula I, a compound represented by formula II, a compound represented by formula III, or a compound represented by formula IV: 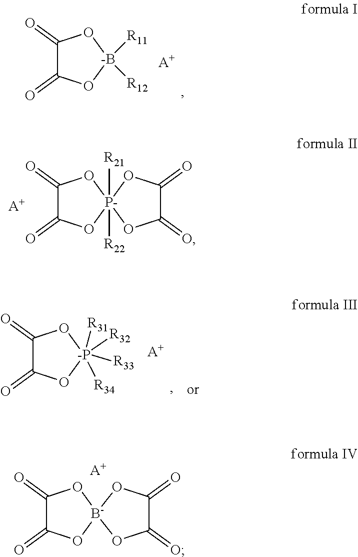
wherein R¹¹, R¹², R²¹, R²², R³¹, R³², R³³, and R³⁴ are independently selected from —CN, a halogen atom, a C₁-C₄ alkyl group substituted by a halogen atom, a C₂-C₄ alkenyl group substituted by a halogen atom, or a C₂-C₄ alkynyl group substituted by a halogen atom; A is selected from Li, Na, K, or Cs.

19. The electronic apparatus according to claim 18, wherein the compound represented by formula I comprises at least one of the following compounds: 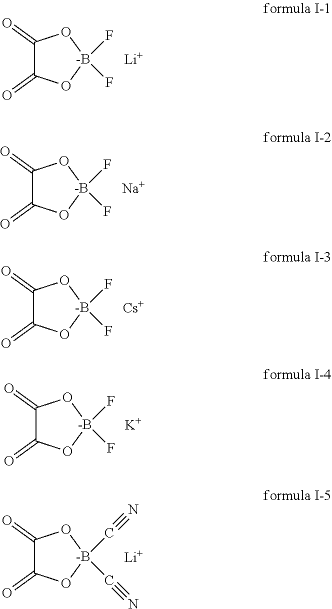
formula I-1, formula I-2, formula I-3, formula I-4, or formula I-5;
the compound represented by formula II comprises at least one of the following compounds: 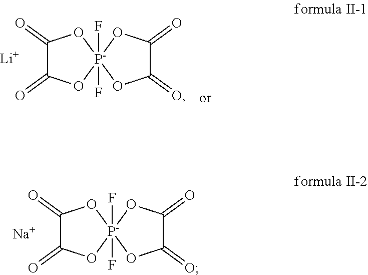 [SMILES: [Li+] ; O=C1O[P-]2(F)(F)(OC1=O)OC(=O)C(=O)O2 ; [Na+] ; O=C1O[P-]2(F)(F)(OC1=O)OC(=O)C(=O)O2]
the compound represented by formula III comprises at least one of the following compounds: 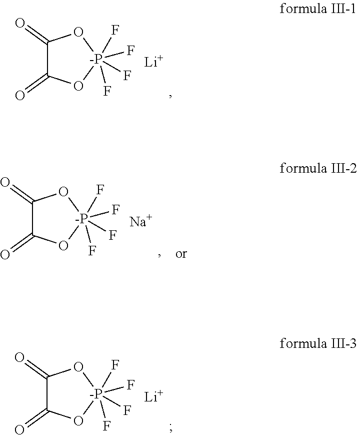
the compound represented by formula IV comprises at least one of the following compounds:

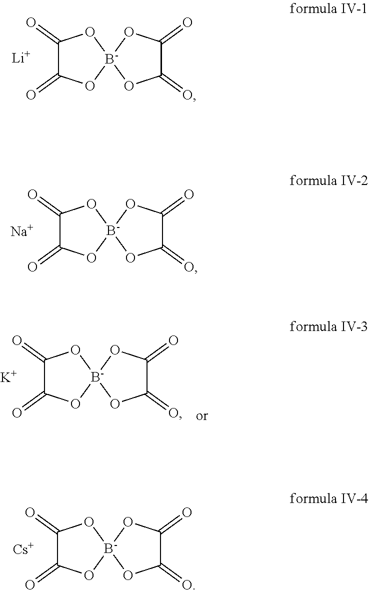

20. The electronic apparatus according to claim 18, wherein based on a total mass of the electrolyte, a mass percentage of the additive Sa1 is 0.1% to 5%.
